(19) United States
(12) Patent Application Publication
(10) Pub. No.: US 2006/0104430 A1
(43) Pub. Date: May 18, 2006

(54) Method for multiple dialing by phone

(75) Inventors: Dustin Kirkland, Austin, TX (US); Herman Rodriguez, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 10/988,474

(22) Filed: Nov. 12, 2004

(51) Int. Cl. H04M 3/42

(52) U.S. Cl. 379/211.04; 379/211.01

(57) ABSTRACT

The present invention is a method for multiple dialing by phone. The method for multiple dialing includes: programming the phone with a configurable software algorithm that provides the phone with a multiple dialing feature; triggering the multiple dialing feature; and, causing the phone to place calls to each phone number in a set of pre-programmed phone numbers by sending a transmission to each of the numbers. Calls to each of the pre-programmed phone numbers in the set may be placed by sending a transmission to each of the numbers either serially or in parallel.

### FIELD OF THE INVENTION

The present invention relates to the field of telecommunications and particularly to a method for multiple dialing by phone.

### BACKGROUND OF THE INVENTION

In today's busy world, the ability to quickly contact someone by telephone is invaluable. However, contact information for individuals will often include multiple phone numbers. For example, an individual may have three phone numbers at which he or she can be reached, such as a home phone number, a work phone number and a cell phone number. This can be inconvenient for a caller who is not certain where that individual will be at a given time. For instance, a caller attempting to reach the individual may be required to locate and dial three separate phone numbers. Currently, an available feature of cellular service providers allows a cell phone customer to register multiple phone numbers (cell phone number, office number, home number, etc.) with the cellular service provider. This way, when a caller dials the customer's cell phone number, it will trigger a series of calls, one to each of the customer's registered numbers. However, if the customer wishes to contact someone else in a like manner, the customer can only do so if the desired contact has registered multiple phone numbers with the cellular service provider.

Therefore, it would be advantageous to have a method for multiple dialing by phone, which allows a caller to place calls to a contact at a series of phone numbers, either serially or in parallel, without directing the calls through a server and independent of features which may or may not be present with respect to the contact's phones.

### SUMMARY OF THE INVENTION

Accordingly, the present invention is directed to a method for multiple dialing by phone, which includes the steps of: programming the phone with a configurable software algorithm that provides the phone with a multiple dialing feature; triggering the multiple dialing feature; and causing the phone to place calls to each phone number in a set of pre-programmed phone numbers by sending a transmission to each of the numbers.

In an embodiment of the invention, transmission to each of the numbers occurs in parallel. In embodiments where transmission occurs in parallel, the method for multiple dialing further includes the multiple dialing feature causing the phone to automatically disconnect the remaining calls if a call is answered at one of the pre-programmed phone numbers in the set.

In further embodiments, transmission to each of the numbers occurs serially. In embodiments where transmission occurs serially, the method for multiple dialing further includes the multiple dialing feature causing the phone to not place any further calls if a call is answered at one of the pre-programmed phone numbers in the set.

In additional embodiments, transmission is adjustably programmable and may occur either in parallel or serially.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart illustrating a method for multiple dialing by phone in accordance with an exemplary embodiment of the present invention;

FIG. 2 is a flowchart illustrating a method for triggering a multiple dialing feature of a phone in accordance with an exemplary embodiment of the present invention;

FIG. 3 is a flowchart illustrating a method for multiple dialing by phone wherein transmission to a set of pre-programmed phone numbers for a given contact occurs in parallel in accordance with an exemplary embodiment of the present invention; and,

FIG. 4 is a flowchart illustrating a method for multiple dialing by phone wherein transmission to a set of pre-programmed phone numbers for a given contact occurs serially in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

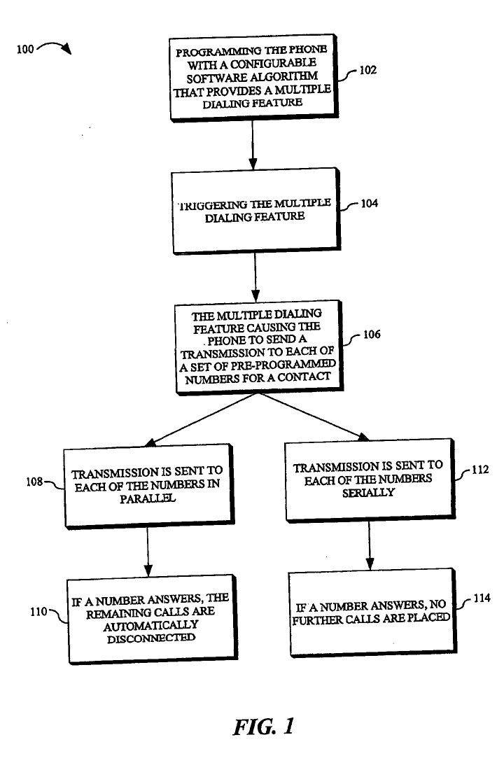

Referring generally to FIG. 1, a method for multiple dialing by phone 100 in accordance with an embodiment of the present invention is discussed. The method 100 includes programming a telephone with a configurable software algorithm that provides the phone with a multiple dialing feature 102. In a present embodiment, the telephone is a cell phone that is programmed with the configurable software algorithm in accordance with the present invention.

The method 100 further includes triggering the multiple dialing feature 104. In a present embodiment, the multiple dialing feature is triggered by dialing one of a set of multiple pre-programmed phone numbers for a contact. For example, a cell phone customer uses the keypad of his or her cell phone to manually dial one of the set of pre-programmed phone numbers. In the present embodiment, one or more sets of pre-programmed phone numbers, each set associated with a respective contact, are programmed into and stored in a contact list of the cell phone. For instance, the cell phone customer manually programs the desired names and numbers into his or her cell phone for storage in the cell phone's directory. In the present embodiment, multiple phone numbers are stored for each contact entered, such as a contact's home, business and cell phone numbers.

In additional embodiments, the multiple dialing feature is triggered via voice recognition dialing or the like. In further embodiments, the multiple dialing feature is triggered by receipt of a function, such as a (*)(61) function on the phone.

The method further includes the multiple dialing feature causing the phone to place calls to each phone number in a set of pre-programmed phone numbers for a contact by sending a transmission to each of the numbers 106. In an embodiment, transmission to each of the numbers 106 occurs in parallel 108. In embodiments where transmission occurs in parallel, if a number answers, the remaining calls are automatically disconnected 110. In further embodiments, transmission to each of the numbers 106 occurs serially 112. In embodiments where transmission occurs serially, if a number answers, no further calls are placed 114.

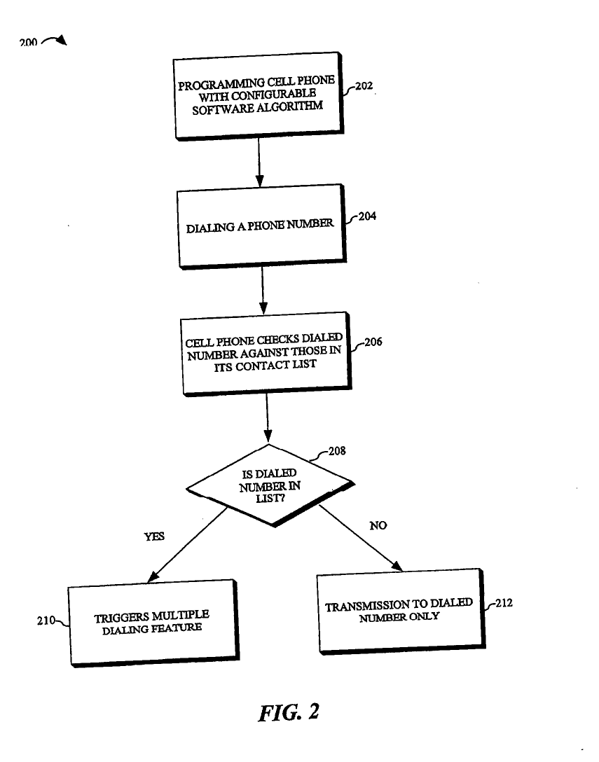

Referring generally to FIG. 2, a method for triggering a multiple dialing feature of a phone 200 in accordance with an embodiment of the present invention is discussed. The method 200 includes programming a telephone with a configurable software algorithm that provides the phone with a multiple dialing feature 202. In a present embodiment, the telephone is a cell phone that is programmed with the configurable software algorithm in accordance with the present invention. A number is then dialed into the cell phone 204. The cell phone proceeds to check the dialed number against those in its contact list 206 to determine if the dialed number is present in the contact list 208. If the dialed number is present in the contact list, the multiple dialing feature of the phone is triggered 210. If the dialed number is not present in the contact list, multiple dialing is not triggered and a transmission is sent which places a call only to the dialed number 212.

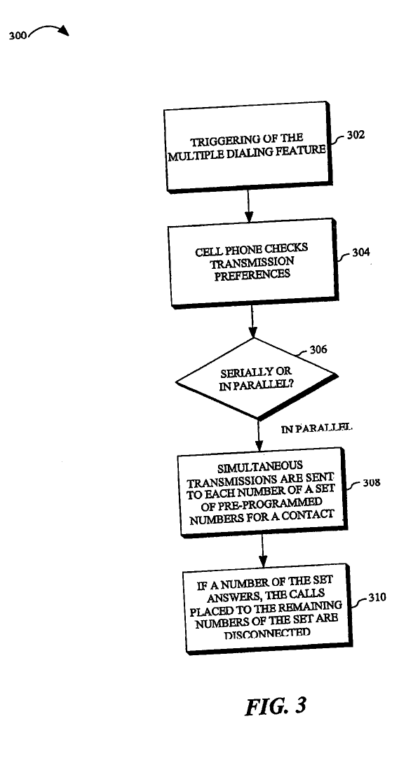

Referring generally to FIG. 3, a method for multiple dialing by phone wherein transmission to a set of pre-programmed phone numbers for a given contact occurs in parallel 300 in accordance with an exemplary embodiment of the present invention is discussed. A cell phone customer uses his or her cell phone to dial one of a set of pre-programmed phone numbers in the contact list for a given contact, thereby triggering the multiple dialing feature of the cell phone 302. The cell phone proceeds to check its transmission preferences 304. Transmission preferences determine whether the cell phone will send transmissions to the set of pre-programmed numbers in parallel or serially 306. In the exemplary embodiment illustrated in FIG. 3, the transmission preferences of the cell phone are programmed to send transmissions in parallel.

In additional embodiments, transmission preferences of the cell phone are adjustably programmed, so that the multiple dialing feature causes the phone to send a transmission to each of the pre-programmed phone numbers for a given contact either serially or in parallel as chosen by the programmer. For example, the programmer may be a cell phone customer who enters his or her transmission preferences manually via the cell phone's keypad in response to instructions or prompts displayed on a display of the cell phone.

The multiple dialing feature proceeds to cause the cell phone to place calls to each of a set of pre-programmed phone numbers for a contact by sending a transmission to each of the numbers in parallel 308. During parallel transmission, if the customer's cell phone is pre-programmed, for example, with three associated numbers for a given contact, such as the contact's home phone number, business phone number and cell phone number, the multiple dialing feature will cause all three numbers to ring simultaneously.

In embodiments where transmission occurs in parallel, the method for multiple dialing further includes the multiple dialing feature causing the phone to automatically disconnect the remaining calls if a call is answered at one of the pre-programmed phone numbers in the set 310. For example, if the contact's cell phone is answered, the simultaneous calls placed to the contact's home phone and business phone will automatically disconnect.

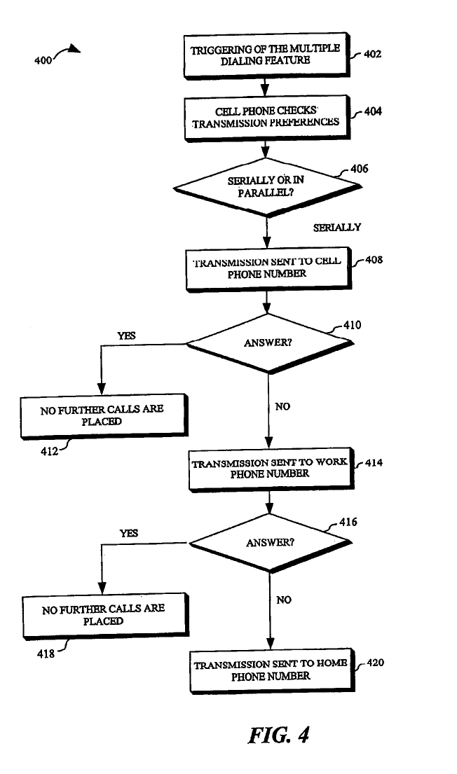

Referring generally to FIG. 4, a method for multiple dialing by phone wherein transmission to a set of pre-programmed phone numbers for a given contact occurs serially 400 in accordance with an exemplary embodiment of the present invention is discussed. A cell phone customer uses his or her cell phone to dial one of the pre-programmed phone numbers for a given contact, thereby triggering the multiple dialing feature of the cell phone 402. The cell phone proceeds to check its transmission preferences 404. The transmission preferences determine whether the cell phone will send transmissions to the set of pre-programmed numbers in parallel or serially 406. In the exemplary embodiment illustrated in FIG. 4, the transmission preferences of the cell phone are programmed to send transmissions serially.

In embodiments where transmission occurs serially, the transmission preferences may be adjustably programmed to allow the multiple dialing feature to cause the phone to send a transmission to each of the pre-programmed phone numbers for a given contact in a pre-programmed sequence. For example, a contact may have two phone numbers: a home number and a work number. During certain hours, for instance, from 8 a.m.-5 p.m., the transmission preferences may be programmed so that a transmission is sent to the contact's work number first, followed by a transmission to the contact's home number. During evening and early morning hours, such as from 5 p.m-8 a.m., the transmission preferences may be programmed so that a first transmission is sent to the contact's home number, followed by a transmission to the contact's work number.

The multiple dialing feature proceeds to cause the customer's cell phone to place calls to each of a set of pre-programmed phone numbers for a contact by sending a transmission to each of the numbers serially. In this example, a set of three pre-programmed numbers including the contact's cell phone, work phone and home phone are stored in the customer's cell phone. The customer's cell phone places a first call by sending a transmission to the contact's cell phone number 408. The contact's cell phone will ring for a preset number of rings as the customer (i.e.—caller) awaits an answer 410. In an embodiment, the preset number of rings (ring preference) of a phone is programmed by a phone manufacturer or provider. In additional embodiments, the ring preference is adjustably programmed by a user of the phone. If the contact's cell phone is answered before the preset number of rings has occurred, no further calls are placed 412. If the contact's cell phone is not answered before the preset number of rings has occurred, the call to the cell phone will disconnect, and the multiple dialing feature will cause the customer's cell phone to place a subsequent call to the contact's work phone 414. The contact's work phone will ring for a preset number of rings as the customer (i.e.—caller) awaits an answer 416. If the contact's work phone is answered before the preset number of rings has occurred, no further calls are placed 418. If the contact's work phone is not answered before the preset number of rings has occurred, the call to the cell phone will disconnect, and the multiple dialing feature will cause the customer's cell phone to place a subsequent call to the contact's home phone 420. If no answer occurs at the contact's home phone before the preset number of rings has occurred, the call to the home phone will disconnect, and the multiple dialing feature will make no further calls.

In further embodiments, if a customer's phone sends a transmission to all of the pre-programmed phone numbers for a given contact and an answering service, such as a voice mail service, picks up at one of the numbers, the multiple dialing feature allows the customer to record a single voice message that goes to voice mail boxes at all of the pre-programmed numbers for that contact which have voice mail service.

In additional embodiments, if a voicemail service answers at one of the pre-programmed phone numbers in the set, the multiple dialing feature allows for disconnection of the answered call and subsequent placement of a call to another phone number within the set.

In further embodiments, the method for multiple dialing further includes the multiple dialing feature being enabled or disabled. For example, a cell phone customer may be able to enable or disable the multiple dialing feature on his or her cell phone as desired by manipulation or activation of a function, a switch or the like.

It is believed that the method of the present invention and many of its attendant advantages will be understood by the forgoing description. It is also believed that it will be apparent that various changes may be made in the form, construction and arrangement of the steps thereof without departing from the scope and spirit of the invention or without sacrificing all of its material advantages. The form herein before described being merely an explanatory embodiment thereof.

What is claimed is:

1. A method for connecting a telephone call, comprising:
identifying a called party;
selecting a dialing mode; and
dialing each telephone number associated with the called party based on the dialing mode;
wherein the dialing mode is in parallel.

2. A method for connecting a telephone call as claimed in claim 1, wherein upon connection to the called party, dialing attempts to telephone numbers other than the number connected are automatically disconnected.

3. A method for connecting a telephone call as claimed in claim 1, wherein the telephone is a cell phone.

4. A method for connecting a telephone call as claimed in claim 1, wherein if a voicemail service answers at one of the phone numbers for the called party and a voicemail message is recorded, automatically sending the voicemail message to voicemail boxes at all of the phone numbers for the called party that have voicemail service.

5. A method for connecting a telephone call, comprising:
identifying a called party;
selecting a dialing mode; and
dialing each telephone number associated with the called party based on the dialing mode;
wherein the dialing mode is serial.

6. A method for connecting a telephone call as claimed in claim 5, wherein upon connection to the called party, no further dialing attempts are made.

7. A method for connecting a telephone call as claimed in claim 5, wherein the telephone is a cell phone.

8. A method for connecting a telephone call as claimed in claim 5, wherein if a voicemail service answers at one of the phone numbers for the called party and a voicemail message is recorded, automatically sending the voicemail message to voicemail boxes at all of the phone numbers for the called party that have voicemail service.

9. A method for connecting a telephone call as claimed in claim 5 wherein if a voicemail service answers at one of the phone numbers for the called party, allowing for disconnection of the answered call and subsequent placement of a call to another phone number for the called party.

10. A method for connecting a telephone call, comprising:
identifying a called party;
selecting a dialing mode; and
dialing each telephone number associated with the called party based on the dialing mode;
wherein the dialing mode is in parallel or serial.

11. A method for connecting a telephone call as claimed in claim 10, wherein if the dialing mode is in parallel, upon connection to the called party, dialing attempts to telephone numbers other than the number connected are automatically disconnected.

12. A method for connecting a telephone call as claimed in claim 10, wherein if the dialing mode is serial, upon connection to the called party, no further dialing attempts are made.

13. A method for connecting a telephone call as claimed in claim 10, wherein the telephone is a cell phone.

14. A method for connecting a telephone call as claimed in claim 10, wherein if a voicemail service answers at one of the phone numbers for the called party and a voicemail message is recorded, automatically sending the voicemail message to voicemail boxes at all of the phone numbers for the called party that have voicemail service.

15. A method for connecting a telephone call as claimed in claim 10, wherein if a voicemail service answers at one of the phone numbers for the called party, allowing for disconnection of the answered call and subsequent placement of a call to another phone number for the called party.
